(19) United States
(12) Patent Application Publication
(10) Pub. No.: US 2009/0077056 A1
(43) Pub. Date: Mar. 19, 2009

(54) CUSTOMIZATION OF SEARCH RESULTS

(75) Inventors: Shanmugasundaram Ravikumar, Berkeley, CA (US); Andrew Tomkins, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 11/856,327

(22) Filed: Sep. 17, 2007

(51) Int. Cl. G06F 17/30

(52) U.S. Cl. 707/5; 707/E17.014

(57) ABSTRACT

Methods and apparatus are described which enable the customization of search results. Various embodiments of the invention relate to machine-readable representations of configurations of one or more components of a search results page. The machine-readable representations are operable in conjunction with a search engine to present, in response to a search query, one or more search results in an interface in accordance with the corresponding configuration.

### BACKGROUND OF THE INVENTION

The present invention relates to the presentation of search results and, in particular, to techniques by which the presentation of search results may be customized.

Users of the World Wide Web are familiar with the various services available on the Web for locating content of interest. Search engines are provided by a number of entities and search capabilities are embedded in many web sites. Web users are also familiar with the manner in which search results are presented by the various search engines and utilities.

FIG. 1 illustrates an example of one approach to the presentation of search results employed by Yahoo!® Inc. of Sunnyvale, Calif. In the example shown, a search for content relating to “social networking” returned a search results page 100 which includes “sponsored” search results (i.e., search results which appear because the sponsors have paid for placement in response to specific search keywords) at the top (102) and right hand side (104) of the page, and organic search results (i.e., search results which appear because they have some objective measure of relevance to the keywords) down the left hand side (106) of the page below sponsored search results 102. Each of the organic search results typically includes a number of components such as, for example, a title 108, a description or abstract 110 (which might include text from the actual web page to which the search result points), a link 112 to cached content, etc. As will be understood, the manner in which the various search results and search results components are arranged and presented is typically controlled by the search provider.

### SUMMARY OF THE INVENTION

According to the present invention, various methods and apparatus are provided which enable the customization of search results. According to a specific embodiment, methods and apparatus are provided for facilitating customization of search results. A user is enabled to specify a plurality of configurations of one or more components of a search results page. A plurality of machine-readable representations of the plurality of configurations specified by the user are stored. Each machine-readable representation is operable in conjunction with a search engine to present, in response to a search query, one or more search results in an interface in accordance with the corresponding configuration specified by the user. Each machine-readable representation is associated with a query class for which the machine-readable representation is to be invoked.

According to another specific embodiment, method and apparatus are provided for facilitating customization of search results. In response to a search query, one of a plurality of machine-readable representations is identified with reference to a query class to which the search query corresponds. Each machine-readable representation represents a configuration of one or more components of a search results page and has an associated query class for which the machine-readable representation is to be invoked. One or more search results responsive to the search query are presented in an interface in accordance with the configuration represented by the identified machine-readable representation.

According to another specific embodiment, at least one computer-readable medium is provided having a plurality of machine-readable representations stored therein. Each machine-readable representation represents a configuration of one or more components of a search results page. Each machine-readable representation is operable in conjunction with a search engine to present, in response to a search query, one or more search results in an interface in accordance with the corresponding configuration. Each machine-readable representation is associated with a query class for which the machine-readable representation is to be invoked.

According to various embodiments, the one or more components may include one or more of: locations in the interface of at least some of the components, a format for individual search results, metadata in the search results, user-generated information in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived

A further understanding of the nature and advantages of the present invention may be realized by reference to the remaining portions of the specification and the drawings.

### BRIEF DESCRIPTION OF THE DRAWINGS

FIG. 1 is a screen shot illustrating a conventional presentation of search results.

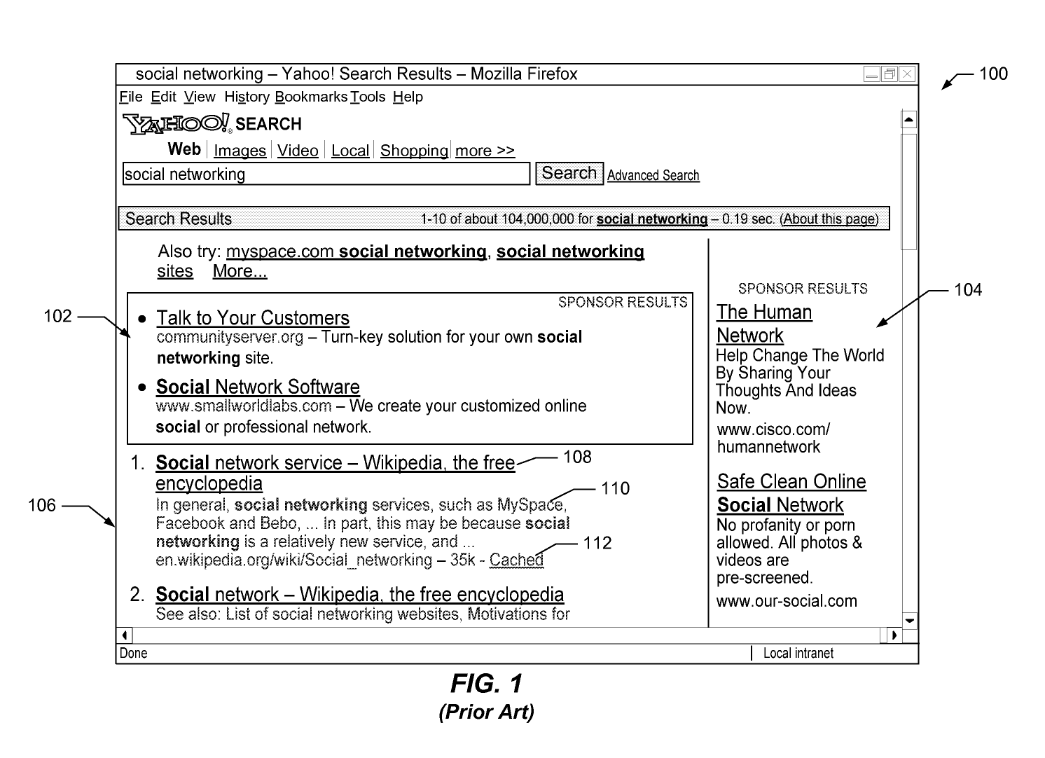

FIG. 2 is a flowchart illustrating a technique by which a search results page template may be configured according to a specific embodiment of the invention.

FIG. 3 is a flowchart illustrating a technique by which a search results page template is invoked according to a specific embodiment of the invention.

FIG. 4 is a simplified diagram of an example of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The invention generally relates to a capability with which an individual user can engage to modify and thereby customize his or her experience of an online service such as, for example, a search service. Some embodiments of the invention relate to various ways in which such a user may share these customizations with others in a shared computing context, environment, or ecosystem.

Specific embodiments of the present invention enable a user to specify the configuration of at least some of the components of a search results page. According to one class of embodiments, this is enabled through the use of search results page templates which allow the user to specify certain customizations and, according to some implementations, when a particular template is to be invoked (e.g., for a specific type or class of query). As used herein, the term “query class” refers to a group or category of queries having some common characteristic. For example, a query class might include queries which relate to a particular type of product or service. In another example, a query class might include queries which relate to a particular subject matter area, e.g., sports, entertainment, news, etc. In yet another example, a query class might include queries which relate to a particular type of media, e.g., video, audio, images, etc. As will be understood with reference to the foregoing examples, a query class may correspond to virtually any manner in which a query may be classified, and should therefore not be used in a restrictive manner.

Allowing users to customize search results may enable a search provider to effectively differentiate its services from those of other providers and generate some level of user loyalty. That is, many users of search services on the Web have come to consider the major search providers as largely interchangeable and, because most users don't readily discern any significant differences in the quality of search results, often don't exhibit any particular loyalty to one provider over another. Customization allows users to create a more satisfying experience and represents an investment on the part of the user which is likely to result in a greater degree of loyalty.

As indicated above, specific embodiments of the invention are described herein with reference to the use of templates which, when specified by a user, are used to control the configuration of the components of a search results page. It should be noted at the outset, however, that the templates described below are merely examples of mechanisms by which the presentation of search results may be customized. More generally, any of a wide variety of mechanisms for controlling the configuration and presentation of web pages may be employed without departing from the scope of the invention. For example, certain aspects of a page of search results can be learned based on the behavior of the user or the behavior of other users. For example, the user could employ a configuration in which search results are re-ranked according to the number of clicks generated by the current user, falling back to other users similar to the current user. This doesn't represent a template, i.e., it influences the ranking rather than the display. Similarly, machine learning techniques could be employed to modify the inclusion of certain modules in a template based on the success of including such modules in the past. Such a configuration could be viewed as a self-modifying template that would adapt to the user.

According to a specific embodiment of the invention, a search results page template represents a family of customizations which may be used to generate search results pages reflecting the customizations. The customizations may be defined by an end user, or may be part of previously defined templates which are made available to end users. Such customizations may include, for example, the overall look and feel of a page, the arrangement or layout of the various components of a page, the format of individual results, and possibly even selection or filtering of the sources from which the search results are derived, as well as the type of information presented.

A user might define or select “horizontal” templates, i.e., templates which may be used to configure search results across different types of searches. For example, a horizontal template could be specified to provide as many results on a page as possible. In such a case, the user might specify, for example, that the template be available as a default for most or all types of searches, that each search result have an abstract which only occupies one line (rather than the two or three lines in conventional results), that the abstract font size be relatively small, etc.

In another example, a template might be specified in which each search result includes components of particular interest or relevance to the user. For example, a user might specify that, when available, each search result include information from an auxiliary source of metadata to help the user better understand the result (e.g., del.icio.us tags; digg.com ratings; stumbleupon.com ratings; metadata, ratings, or other information generated by specific individuals; etc.). Alternatively, the user might specify that information be included in a search result when anyone in his or her community (e.g., as defined by a contacts list or other ecosystem group) has some relationship to the particular search result (e.g., authorship, commentary, reference in a blog, reviews, ratings, additional metadata, etc.).

A user might also define or select “vertical” templates, i.e., templates which may be used to configure search results for specific types or classes of queries. For example, a user might define a product template which might be invoked when the search keyword is recognized as a product. Such a product template might specify, for example, that the results page include a picture of the product, pricing information, and Web results relating to the product. Such a product template might then be specified to be invoked for anything that falls into the “product” category or query class.

In a more specific example, a product template could even be specified that is invoked only for a particular type or class of products, e.g., cameras. In such a case, the results might be specified to include very specific metadata or other information relating to that type of product, e.g., number of megapixels, lens type, etc.

The manner in which a specific template is invoked may vary considerably in accordance with various embodiments of the invention. For example, a user might explicitly select a template from available options in conjunction with or prior to initiating a search. In another example, a user might be enabled to tie certain classes of queries to specific templates by specifying that queries containing specific keywords or phrases are to have results returned using a particular template. The appropriate template would then be selected on the fly in response to such queries. In addition, machine intelligence and/or learning might be employed to process queries and/or results and map them to available templates. For example, algorithms for parsing strings of text could be applied to queries for this purposes. In such a case, the parsed text could simply be mapped to a particular category and its corresponding template. In other examples, various information could be evaluated to determine the subject matter or query class, and therefore the appropriate template. Examples of such information could include preliminary search results returned in response to a query, a series of queries from a user, feedback from a user, etc. It should be noted that the foregoing are merely examples, and that any of a wide variety of techniques may be employed for invoking particular templates without departing from the scope of the invention.

As mentioned above and according to specific embodiments of the invention, specific templates may be associated with and invoked by one or more query classes. When a user or a search provider specifies a template, a query class may be specified. Examples of such query classes might include, but are not limited to, movies names, sports figures, actors/actresses, politics, multimedia, products, tech products, blogs, news or current events, etc. Moreover, existing query classes may be extended or refined to create new query classes for which templates may be specified for presentation of search results for those classes. According to some of these embodiments, a simple language may be used to specify a new query class and to extend or refine an existing query class. For example, a query class could be defined by a regular expression (this is a very simple example of such a language). Additionally, a query class could be defined by a regular expression augmented with special operators to provide stemming, or more sophisticated linguistic processing such as lemmatization, or matching verb classes such as verbs of motion, or matching certain types of entities such as dates, times, geographic locations, and the like.

According to specific embodiments, a plurality of horizontal and/or vertical templates are made available to users of search services. These templates may be generated and/or made available by the search provider, one or more of the users themselves, a third party template provider, or any combination of these. In addition, users may be provided with tools to modify and/or extend existing templates, as well as create new templates. Such tools might be enabled, for example, using a stylesheet language, e.g., cascading style sheets (CSS) or related technologies, which are used to describe the presentation of a document written in a markup language. In addition, more visually oriented tools could be employed which provide, for example, visual representations of search results pages and/or individual search results in which the relative sizes, locations, and other attributes of the various visual components may be manipulated in the interface by the individual specifying the template. The wide variety of tools and languages which are suitable for specifying the various customizations enabled by the present invention will be apparent to those of skill in the art.

Some examples of the types of customizations which may be represented in templates generated according to various embodiments of the invention may be instructive. It should be noted, however, that the following are merely examples and should not be used to limit the scope of the invention. Rather, as will be understood, there are a huge number of possible customizations enabled by and within the scope of the present invention.

According to some embodiments, a variety of customizations which apply globally to a search results page may be specified. In one example, the number of results per page may be specified. In another, formatting (e.g., font, font size, colors, styles, etc.) or the locations of various items on the page may be specified. As will be understood, in such cases, it may be advisable to place limits on the modifications a user may make. For example, in some cases the search provider may not want to allow removal of its brand name or modification or removal of any advertising or paid content, e.g., sponsored links. In such cases, some customization options might be limited to the organic search results.

The components of which individual search results are composed may also be customized according to some implementations. That is, as described above, a conventional search result typically includes a number of components, the selection and arrangement of which is typically static and entirely within the control of the search provider. By contrast, some embodiments of the invention allow customization of the components of individual search results including, for example, the overall arrangement and order of components, emphasis or de-emphasis of particular components, upsizing or downsizing of particular components, inclusion or removal of particular components, etc. Conventional components of search results which may be customized include, for example, the title, the description, the cached result link, etc.

In addition, a wide variety of other types of components may be included in individual search results and/or customized in accordance with specific implementations. For example, search results could be customized to include a “More like this” link or a “Similar pages” link selection of which results in additional results or links to information or pages having similarities with the primary search result. An individual search result might also be customized to include one or more links selection of which results in some operation relating to the primary search results, e.g., “Open link in new tab,” “blog this,” “digg this,” “add to favorites,” etc. A search result might be customized to include links to other pages associated with the page described by the primary result, e.g., links to home pages or so-called “deep links” to pages that may be more targeted entry points. A search result might be customized to include a thumbnail image of the described page.

A search result might also be customized such that it is interactive in some way, i.e., the representation or substance of the results changes in some way in response to a user action. For example, a template could be specified to generate search results which transform in some way in response to a specified user action, e.g., when moused over. Such transformation might include, for example, producing a thumbnail, a more detailed abstract, a richer set of information, etc. Alternatively, a control (e.g., a button or link) could be associated with an individual search result which, when selected, results in expansion of the information in the result, e.g., a richer presentation, and/or presentation of more of the corresponding page or associated pages.

As mentioned above, in some instances, certain customizations might be limited only to the organic search results as search providers have an interest in maintaining control over other types of results, e.g., sponsored search results. However, it should be noted that implementations are contemplated in which few or no such limitations exist.

Other customizations which may be enabled include, for example, allowing the specification of particular data sources or types of information which may be included, excluded, or weighted relative to other data sources, when generating search results. Examples of different data sources or information types which could be specified in this manner include the World Wide Web generally (i.e., Web results), specific Web media properties (e.g., Yahoo! Answers, Flickr, Upcoming, del.icio.us, etc.), specific online resources (e.g., Wikipedia and related databases, the Library of Congress, etc.), particular types of media (e.g., images, video, audio, etc.), and so on.

According to some implementations, the results associated with particular sources or types of information may be grouped together in a variety of ways. For example, tabs may be provided for each source or type of information, selection of which results in presentation of the results associated with that tab. Alternatively, results associated with different sources or types of information may be presented in the same interface with some visual distinction, partitioning, or segmentation of the results in the interface. According to one set of embodiments, the formatting of an individual result might be dependent on the information source that provided that result. This could be as simple as, for example, showing results from a particular source in a larger font. Alternatively, such embodiments might employ more sophisticated techniques such as, for example, inlining author information on results from bulletin boards. Again, the manner in which results may be grouped and presented may vary considerably without departing from the scope of the invention.

In addition, a template may be specified to trigger special purpose modules, initiate particular actions, or include particular components in search results depending on the information included or associated with particular search results. For example, when a result includes the name of an individual, biographical information about the person could be included with the result. Or when the result includes a geographic location, geographic information about the location could be included with the result (e.g., a representation of or link to a map or current weather conditions). Or when the result identifies a movie or song, information about the movie or song or the associated artist(s), or a link to a clip from the movie or song could be included with the result. As will be understood, the number of possible options, variations, and combinations is vast.

It should also be noted that embodiments of the invention are contemplated in which the operation of the underlying search engine is largely unaffected by the overlying use of templates. That is, in response to a search query, the search engine may acquire information relating to the search query as it would conventionally, i.e., without the benefits of or reference to the customizations enabled by the present invention. The customizations of the appropriate template are then applied to the conventionally retrieved results. However, embodiments are also contemplated in which the operation of the underlying search engine is altered in some way to enable at least some customizations. For example, if a customization related to inclusion of information in each search result which the underlying search engine was not previously configured to retrieve, the operation of the engine may need to be modified in some way to retrieve or facilitate access to the necessary information for inclusion in the search results.

According to some embodiments, search results page customizations (e.g., as embodied by templates) may be published and shared with other users, e.g., within a community of users operating in a shared computing context, environment, or ecosystem. For example, registered Yahoo!® users might be given access to a library of templates for use with the Yahoo!® search engine which may include templates generated by Yahoo!® personnel, other Yahoo!® users, or both. Alternatively or in addition, access to templates might be controlled by the user who created them. For example, a specific user might specify a group of users (e.g., his Yahoo!® Messenger contacts list) who may use his templates. Or, a user might transmit templates (or links to templates) to other users, e.g., by email or text message. As will be understood, the manner in which templates might be published or shared may vary considerably without departing from the scope of the invention.

According to one embodiment, customizations (e.g., as embodied by templates) are made available to and are rated by such a community of users. The rating of the customizations may be done explicitly, i.e., by allowing users to vote or otherwise explicitly indicate their favorite customizations. Alternatively, an implicit approach could be used in which, for example, customizations are rated with reference to the frequency with which users employ or share particular customizations. Regardless of how the rating occurs, such an approach enables preferential treatment of highly-rated customizations. For example, such a rating system might result in higher rankings for highly-rated customizations when a user searches for a possible customizations. In another example, highly-rated customizations might be displayed on a “Favorite Customizations” page, or the like.

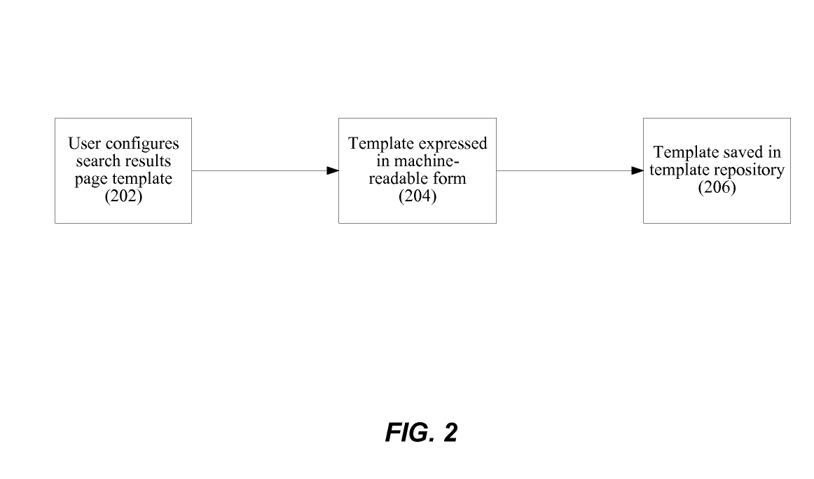

A specific technique by which a template may be configured and made available for use will now be described with reference to the flowchart of FIG. 2. Initially, a user configures a search results page template (202). As described above, this user may be an end user who intends to use the template to customize search results pages for his own searches and/or to share the template with others. Alternatively, the user may be a representative of a search provider who intends to make the template available for use by users of the provider's search engine. As yet another alternative, the user might be a third party provider of templates for use with the provider's search engine. Embodiments are even contemplated in which the “user” is actually an automated process or device which can configure templates using machine intelligence and/or learning.

In addition, the user's configuration of the template can encompass any of a wide variety of actions which result in the generation or modification of a template. For example, it might involve setting up a new template or importing and modifying an existing template. It also might involve setting up or importing one or more query classes, and/or establishing mappings between one or more query classes and the template. More generally, configuration of a template encompasses any action or process by which one or more customizations which may be associated with a template is/are specified.

The template configured by the user is expressed in a machine-readable format. (204). One example of a suitable format is an XML document. The template in its machine readable format is then saved in a template repository or database (206). Expression of the template in machine-readable form may occur as the user is configuring the template or after configuration of the template is complete. In addition, expression of the template in machine readable form and saving of the template in the template repository may occur at the user's device, at a back-end system (e.g., the search provider's or third party provider's system), or over multiple devices in a distributed computing system.

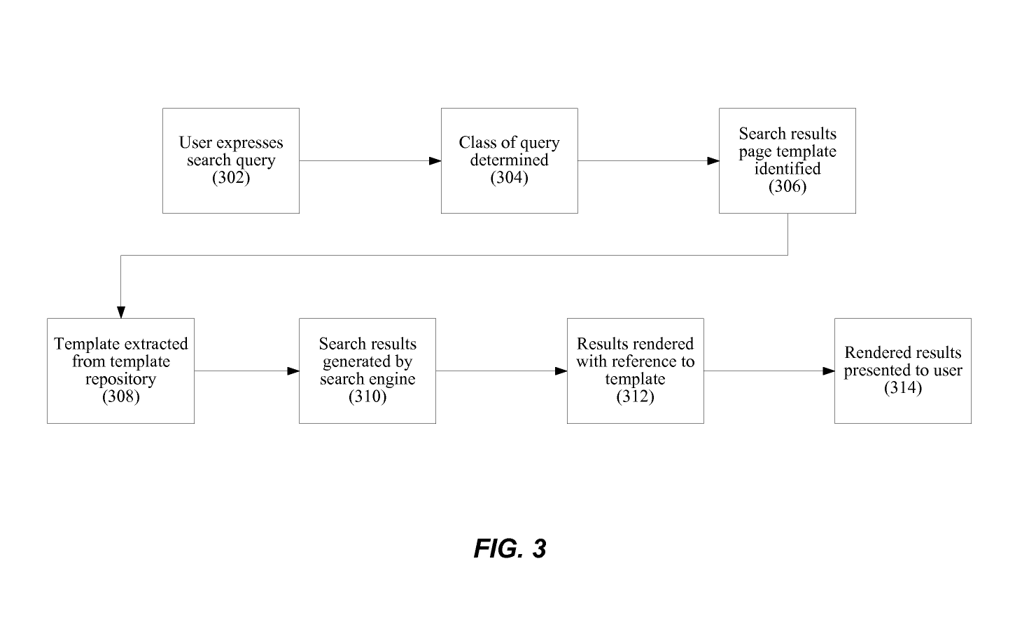

A specific technique by which a template stored in a template repository may be invoked in response to a search query will now be described with reference to FIG. 3. When a user expresses a query (302), e.g., in a search engine query box, the class of the query is determined (304). Determination of the query class may be achieved with reference to an explicit selection by the user, e.g., the user identifies the query class and/or the template to be used. Alternatively, determination of the query class may be done in an automated fashion, e.g., a process associated with the search engine parses the query.

Based at least in part on the query class, the appropriate search results page template is identified (306). Identification of the appropriate template may also be done with reference to information about the user, e.g., a user profile. That is, for example, the user initiating the search may have previously specified that a particular template be used for a particular query class. Thus, the identity of the user and his expressed preferences would be part of the process of identifying the appropriate template. Alternatively, where a user has expressed no such preference, the query class alone could be sufficient for identifying one of a plurality of available default templates.

Once the appropriate template is identified, it is extracted from the template repository (308). The search results are generated by the search engine (310). As discussed above, the operation of the search engine may be entirely conventional, with additional processes operating to render the returned results according to the template. Alternatively, depending on the implementation, various of the functionalities associated with the invention may affect the operation of the underlying search engine. That is, for example, in an implementation in which a template requires information not typically returned with conventional search results, e.g., metadata from specified sources in each result, the search engine may be required to retrieve additional information beyond the conventional results. That is, the customizations specified by the template may inform the search engine about the information it needs to retrieve.

The results are then rendered by the search engine front end with reference to the template (312). That is, the search engine front end refers to the extracted template to determine what information to render and how to render it. The rendered results are then presented to the user (314).

According to a specific embodiment, the user is enabled to apply different templates to the same set of search results. According to one such embodiment, the user initiates a search which is returned either using a template or in a conventional search results page. The user is then provided with a control in the interface (e.g., a menu, one or more buttons, a toolbar option, etc.) which allows reformatting of the search results according to one or more template options. These templates could be published templates, shared templates, the user's own templates, or a combination. This allows users to try on different looks for a set of search results. In some cases, the reformatting could simply be applied to what is depicted in the current results page, or might require the search to be re-initiated depending on what the configuration represented by the template requires.

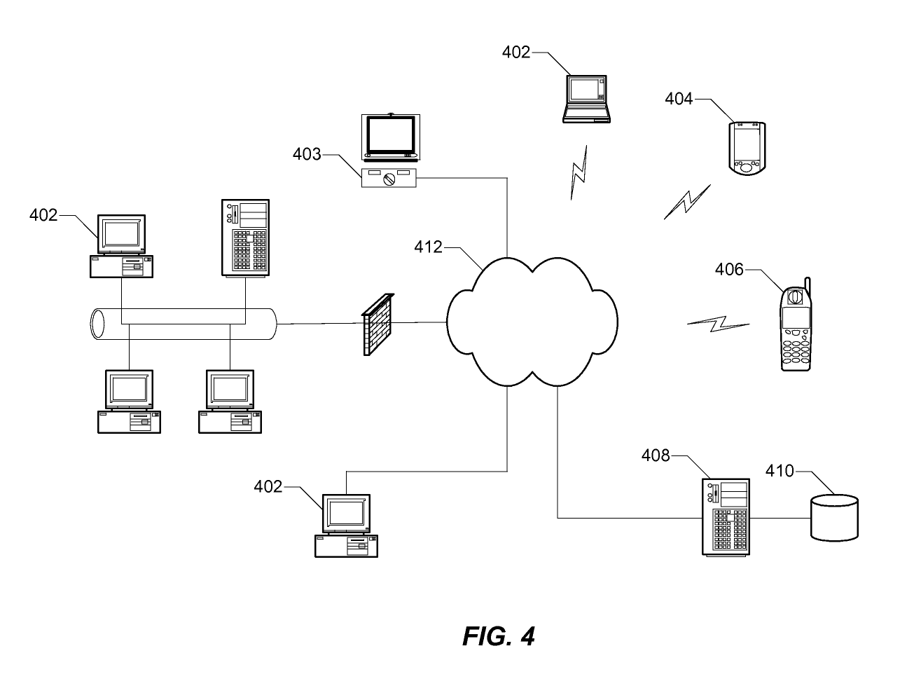

Embodiments of the present invention may be employed to facilitate customization of search results in any of a wide variety of computing contexts. For example, as illustrated in FIG. 4, implementations are contemplated in which the relevant population of users interacts with a diverse network environment via any type of computer (e.g., desktop, laptop, tablet, etc.) 402, media computing platforms 403 (e.g., cable and satellite set top boxes and digital video recorders), handheld computing devices (e.g., PDAs, email clients, etc.) 404, cell phones 406, or any other type of computing or communication platform.

And according to various embodiments, specification of the customization enabled by the presentation may be facilitated using a wide variety of techniques. For example, as described above, a wide variety of tools may be provided by which templates and the query classes to which they apply may be specified. And once specified, these templates and query classes may be stored, published, shared, and invoked in a centralized or distributed manner. The templates and query class definitions may be stored, for example, in a proprietary language which is not visible to users, but which may be specified using tools which are accessible to the users at their respective computing devices. The centralized approach to storage, publishing, sharing, and invocation of templates is represented in FIG. 4 by server 408 and data store 410 which, as will be understood, may correspond to multiple distributed devices and data stores.

The various aspects of the invention may also be practiced in a wide variety of network environments (represented by network 412) including, for example, TCP/IP-based networks, telecommunications networks, wireless networks, etc. In addition, the computer program instructions and data structures with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of templates as the mechanism for representing and instantiating customizations enabled by the present invention. However, it should be understood that templates as described herein are merely examples of such mechanisms. Others might include code integrated within the front end of a search engine, or separate processes which instantiate search results pages with reference to dynamically generated or statically stored parameter values.

Moreover, references herein to the notion of query classes should not be construed as requiring these in all embodiments of the invention. Rather, embodiments are contemplated in which query classes would not be required for enabling the customization of search results pages. For example, embodiments in which a user may explicitly select a desired set of customizations (e.g., as embodied by a template) would not need to employ the concept of query classes to make the selection.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for facilitating customization of search results, comprising:
enabling a user to specify a plurality of configurations of one or more components of a search results page; and
storing a plurality of machine-readable representations of the plurality of configurations specified by the user, each machine-readable representation being operable in conjunction with a search engine to present, in response to a search query, one or more search results in an interface in accordance with the corresponding configuration specified by the user, each machine-readable representation being associated with a query class for which the machine-readable representation is to be invoked.

2. The method of claim 1 wherein the one or more components includes one or more of:
locations in the interface of at least some of the components, a format for individual search results, metadata to be included in the search results, user-generated information to be included in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived.

3. The method of claim 1 further comprising enabling the user to specify the query class for which each of the machine-readable representation is to be invoked.

4. The method of claim 1 further comprising making the machine-readable representations available for use by a plurality of users within a shared computing context.

5. The method of claim 4 further comprising rating the machine-readable representations with reference to input by at least some of the plurality of users, the rating enabling preferential treatment of the machine-readable representations within the shared computing context.

6. A system for facilitating customization of search results, comprising at least one computing device configured to:
enable a user to specify a plurality of configurations of one or more components of a search results page; and
store a plurality of machine-readable representations of the plurality of configurations specified by the user, each machine-readable representation being operable in conjunction with a search engine to present, in response to a search query, one or more search results in an interface in accordance with the corresponding configuration specified by the user, each machine-readable representation being associated with a query class for which the machine-readable representation is to be invoked.

7. The system of claim 6 wherein the one or more components includes one or more of:
locations in the interface of at least some of the components, a format for individual search results, metadata to be included in the search results, user-generated information to be included in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived.

8. The system of claim 6 wherein the at least one computing device is configured to enable the user to specify the query class for which each of the machine-readable representation is to be invoked.

9. The system of claim 6 wherein the at least one computing device is configured to make the machine-readable representations available for use by a plurality of users within a shared computing context.

10. The system of claim 9 wherein the at least one computing device is further configured to rate the machine-readable representations with reference to input by at least some of the plurality of users, the rating enabling preferential treatment of the machine-readable representations within the shared computing context.

11. A computer-implemented method for facilitating customization of search results, comprising:
in response to a search query, identifying one of a plurality of machine-readable representations with reference to a query class to which the search query corresponds, each machine-readable representation representing a configuration of one or more components of a search results page and having an associated query class for which the machine-readable representation is to be invoked; and
presenting one or more search results responsive to the search query in an interface in accordance with the configuration represented by the identified machine-readable representation.

12. The method of claim 11 wherein the one or more components includes one or more of:
locations in the interface of at least some of the components, a format for individual search results, metadata in the search results, user-generated information in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived.

13. The method of claim 11 wherein the identified machine-readable representation is further identified with reference to an identity of a user initiating the search query.

14. The method of claim 13 further comprising identifying the query class with reference to one of a query class selection by the user, or automated analysis of the search query.

15. The method of claim 11 wherein the search results are generated by a search engine, and wherein operation of the search engine requires reference to the configuration represented by the identified machine-readable representation.

16. The method of claim 11 wherein the search results are generated by a search engine, and wherein operation of the search engine occurs without reference to the configuration represented by identified the machine-readable representation.

17. A system for facilitating customization of search results, comprising at least one computing device configured to:
in response to a search query, identify one of a plurality of machine-readable representations with reference to a query class to which the search query corresponds, each machine-readable representation representing a configuration of one or more components of a search results page and having an associated query class for which the machine-readable representation is to be invoked; and
present one or more search results responsive to the search query in an interface in accordance with the configuration represented by the identified machine-readable representation.

18. The system of claim 17 wherein the one or more components includes one or more of:
locations in the interface of at least some of the components, a format for individual search results, metadata in the search results, user-generated information in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived.

19. The system of claim 17 wherein the at least one computing device is configured to further identify the identified machine-readable representation with reference to an identity of a user initiating the search query.

20. The system of claim 19 wherein the at least one computing device is configured to identify the query class with reference to one of a query class selection by the user, or automated analysis of the search query.

21. The system of claim 17 further comprising a search engine for generating the search results, wherein operation of the search engine requires reference to the configuration represented by the identified machine-readable representation.

22. The system of claim 17 further comprising a search engine for generating the search results, wherein operation of the search engine occurs without reference to the configuration represented by the identified machine-readable representation.

23. At least one computer-readable medium having a plurality of machine-readable representations stored therein, each machine-readable representation representing a configuration of one or more components of a search results page, each machine-readable representation being operable in conjunction with a search engine to present, in response to a search query, one or more search results in an interface in accordance with the corresponding configuration, wherein each machine-readable representation is associated with a query class for which the machine-readable representation is to be invoked.

24. The at least one computer-readable medium of claim 23 wherein the one or more components includes one or more of:
locations in the interface of at least some of the components, a format for individual search results, metadata in the search results, user-generated information in the search results, a number of search results per page, at least one global format parameter, links to similar results, links to similar pages, links to related pages, at least one control which invokes an operation relating to associated ones of the search results, thumbnail images for the search results, interactive behavior of selected ones of the search results, groupings of the search results having at least one common characteristic, inclusion of particular components in the search results depending on information associated with the search results, triggering of special purpose modules depending on information associated with the search results, initiation of specific actions depending on information associated with the search results, or sources from which the search results may be derived.
